(19) United States
(12) Patent Application Publication
(10) Pub. No.: US 2024/0201368 A1
(43) Pub. Date: Jun. 20, 2024

(54) METHOD FOR ASCERTAINING A THREE-DIMENSIONAL POSITION OF A REFLECTION POINT OF AN OBJECT IN THE ENVIRONMENT OF A VEHICLE BY MEANS OF AN ULTRASONIC SENSOR, COMPUTER PROGRAM, COMPUTING DEVICE, AND VEHICLE

(71) Applicant: Robert Bosch GmbH, Stuttgart (DE)

(72) Inventors: Dirk Schmid, Simmozheim (DE); Sebastian Olbrich, Weinsberg (DE); Timo Pfeiffer, Leinfelden-Echterdingen (DE); Tom Reimann, Bissingen An Der Teck (DE)

(21) Appl. No.: 18/538,767

(22) Filed: Dec. 13, 2023

(30) Foreign Application Priority Data
Dec. 20, 2022 (DE) 10 2022 214 079.6

(51) Int. Cl. G01S 15/42; G01S 15/931

(52) U.S. Cl. CPC G01S 15/42; G01S 15/931; G01S 2015/937

(57) ABSTRACT

A method for ascertaining a three-dimensional position of a reflection point of an object in the environment of a vehicle using an ultrasonic sensor having at least three sensor elements. At least two sensor elements are arranged at a horizontal offset to one another and at least two sensor elements are arranged at a vertical offset to one another. The method includes: transmitting at least two ultrasonic signals using at least one of the sensor elements of the ultrasonic sensor, wherein the two ultrasonic signals are transmitted chronologically one after the other, and the two ultrasonic signals are transmitted in different spatial directions and/or with respectively differently shaped sonic cones and/or with respectively different ultrasonic frequencies; sensing the transmitted ultrasonic signals, each reflected on an object, as reflection signals using the at least three ultrasonic sensor elements; and ascertaining the three-dimensional position of a reflection point of the object.

### CROSS REFERENCE

The present application claims the benefit under 35 U.S.C. § 119 of German Patent Application No. DE 10 2022 214 079.6 filed on Dec. 20, 2022, which is expressly incorporated herein by reference in its entirety.

### FIELD

The present invention relates to a method for ascertaining a three-dimensional position of a reflection point of an object in the environment of a vehicle by means of an ultrasonic sensor. The present invention also relates to a computer program comprising commands which, when the program is executed by a computer, cause the computer to perform the steps of the method according to the present invention. The present invention furthermore relates to a computing device comprising a computing unit configured to perform the steps of the method according to the present invention. In addition, the present invention relates to a vehicle comprising at least this computing device according to the present invention.

### BACKGROUND INFORMATION

German Patent Application No. DE 10 2019 214 612 A1 describes a method for detecting an object in an environment of a vehicle, wherein the vehicle has an ultrasonic sensor, which monitors the environment of the vehicle, for transmitting and receiving ultrasonic signals.

German Patent Application No. DE 10 2020 211 538 A1 describes a micromechanical component for a sound transducer device.

U.S. Pat. No. 10,605,903 B2 describes an ultrasonic transducer for sensing ultrasonic signals.

German Patent Application No. DE 10 2009 032 541 A1 describes a method with at least one sensor of a driver assistance system, wherein a relative position of an object located outside the vehicle is sensed relative to the sensor and a distance of the object from the vehicle is ascertained on the basis of the sensed position and on the basis of a model for at least one contour of an outer surface of the vehicle, wherein a three-dimensional shape of the outer surface is reproduced in the model.

German Patent Application No. DE 10 2020 213 673 A1 describes methods for warning at least one occupant of a first vehicle of a risk of collision as a result of a vehicle door opening.

An object of the present invention is to improve object detection by means of ultrasonic sensors.

### SUMMARY

The above object may be achieved using features of the present invention.

The present invention relates to a method for ascertaining a three-dimensional position of a reflection point of an object in the environment of a vehicle by means of an ultrasonic sensor. According to an example embodiment of present invention, the ultrasonic sensor comprises at least three sensor elements, which are in particular arranged in a common plane, wherein at least two sensor elements are arranged at a horizontal offset to one another and at least two sensor elements are arranged at a vertical offset to one another. The sensor elements are preferably MEMS sensor elements. According to an example embodiment of the present invention, the method comprises transmitting at least two ultrasonic signals by means of at least one of the ultrasonic sensor elements of the ultrasonic sensor, wherein the two ultrasonic signals are transmitted chronologically one after the other, and wherein the two ultrasonic signals are transmitted in different spatial directions and/or with respectively differently shaped sonic cones and/or with respectively different ultrasonic frequencies. Subsequently, the two transmitted ultrasonic signals reflected on an object are sensed as reflection signals by means of the at least three ultrasonic sensor elements in each case. Thereafter, a three-dimensional position of a reflection point of the object relative to the ultrasonic sensor or to the vehicle is ascertained based on at least three, preferably six, sensed reflection signals, wherein in particular a horizontal position and a vertical height of the reflection point are ascertained or determined. The three-dimensional position of the reflection point of the object is ascertained as a function of three reflection signals which originate from or are assigned to one or both of the two transmitted ultrasonic signals. The ascertainment of the three-dimensional position of the reflection point is in particular ascertained by a trilateration method as a function of the determined path differences and/or the determined phase differences between the respectively transmitted ultrasonic signal and the respectively associated reflection signals sensed at the at least three ultrasonic sensor elements. Alternatively, it may advantageously be provided that the three-dimensional position of the reflection point is ascertained based on three reflection signals, wherein at least two reflection signals originate from different ultrasonic signals. The method results in the advantage that the three-dimensional positions of reflection points can be ascertained more accurately and for a larger angular range in the environment of the vehicle in comparison to conventional methods. By means of the more accurately ascertained position of the reflection points, distances from objects or parking spaces can, for example, be determined or detected more accurately and more reliably.

Preferably, according to an example embodiment of the present invention, the at least two ultrasonic signals are transmitted by means of different ultrasonic sensor elements of the ultrasonic sensor. An efficient and rapidly successive transmission of the two ultrasonic signals in different spatial directions and/or with respectively differently shaped sonic cones and/or with respectively different ultrasonic frequencies is thereby advantageously made possible.

In one embodiment of the present invention, it can be provided that at least one ultrasonic signal is transmitted by means of at least two simultaneously activated, different ultrasonic sensor elements of the ultrasonic sensor, wherein the sonic cone of the transmitted ultrasonic signal is advantageously shaped. This results in the advantage that the sonic cone can be shaped more strongly and the signal amplitude can be amplified.

In one embodiment of the present invention, prior to the transmission of the at least two ultrasonic signals, a current driving situation of the vehicle is detected as a function of the position of the vehicle, as a function of a sensed speed of the vehicle, as a function of an input of the user of the vehicle and/or as a function of a captured camera image of the environment of the vehicle and/or as a function of map data. The method is subsequently carried out or continued with the transmission of the at least two ultrasonic signals as a function of the detected driving situation, in particular if a maneuver situation, a parking process or an unparking process has been detected as the driving situation. The maneuver situation, the parking process or the unparking process is advantageously detected as the current driving situation of the vehicle if the sensed position of the vehicle is located in a parking region, for example on a parking space marked in map data, and/or the sensed speed of the vehicle is less than or equal to a speed threshold value, and/or this driving situation was detected or ascertained or observed at this position in the past.

In a further embodiment of the present invention, a speed of the vehicle is sensed prior to the transmission of the at least two ultrasonic signals. Subsequently, one of the ultrasonic signals is transmitted as a function of the sensed speed, wherein the spatial direction, the shaping of the sonic cone and/or the ultrasonic frequency of the ultrasonic signal is adjusted as a function of the speed. The transmitted ultrasonic signal advantageously has a wider sonic cone in the horizontal direction during standstill of the vehicle than during travel of the vehicle. Alternatively or additionally, the time interval between the transmitted ultrasonic signals is changed or adjusted as a function of the sensed speed, wherein the time interval between the transmitted ultrasonic signals is in particular reduced with increasing speed. This embodiment of the method results in the advantage that the three-dimensional positions of reflection points can also be ascertained with higher accuracy at higher speeds during the travel.

In a particularly preferred embodiment of the present invention, an object in the environment of the vehicle is detected via a trained machine detection method, in particular via a neural network, as a function of a plurality of ascertained three-dimensional positions of respectively different reflection points. The detected object is advantageously assigned to the ascertained three-dimensional positions of the respectively different reflection points. It can be provided that the object is alternatively or additionally ascertained as a function of at least one camera image captured by means of a vehicle camera or as a function of a sequence of captured camera images.

In a development of the preferred embodiment of the present invention, a position and/or an orientation of the detected object in the environment of the vehicle is estimated, in particular in each case relative to the vehicle. The estimation takes place as a function of a main axial direction. The main axial direction is advantageously ascertained as a function of the ascertained three-dimensional positions of the reflection points assigned to the object. In this case, the main axial direction can in particular be ascertained as a function of the smallest mean distance between the reflection points, assigned to the object, and the axis. Alternatively or additionally, the main axial direction is ascertained as a function of a position of a three-dimensional object box around the detected object, wherein the shape of the object box is in particular loaded from a memory based on the detected object and is parameterized as a function of the ascertained three-dimensional positions of the reflection points assigned to the detected object. Alternatively or additionally, the ascertainment of the main axial direction is detected as a function of the plurality of ascertained three-dimensional positions of reflection points via a trained machine detection method, in particular via a neural network. This development advantageously enables an efficient ascertainment or estimation of the position and/or of the orientation of the detected object in the environment of the vehicle, e.g., for ascertaining a predicted movement of dynamic objects for emergency braking assistants or driver assistance functions.

In a further optional development of the present invention, a movement direction and/or a speed of the detected object relative to the vehicle is ascertained based on the positions, estimated over time, of the detected object and/or the orientations, estimated over time, of the detected object and/or the three-dimensional positions, ascertained over time, of reflection points assigned to the object. This development advantageously makes it possible to ascertain a predicted movement of dynamic objects for emergency braking assistants or driver assistance functions.

In addition, it can be provided that a height of the detected object relative to the vehicle is ascertained as a function of the estimated position of the detected object and/or of the estimated orientation of the detected object and/or of the plurality of ascertained three-dimensional positions of reflection points. In this embodiment, the height can be determined reliably and accurately.

In an optional embodiment of the present invention, a collision warning between the vehicle and the detected object is also determined, wherein the dimensions of the vehicle are in particular taken into account. The determination takes place at least as a function of the estimated current position of the detected object. Alternatively or additionally, the collision warning is determined as a function of the estimated current orientation of the detected object. Alternatively or additionally, the collision warning is determined as a function of the ascertained current movement direction of the detected object. Alternatively or additionally, the collision warning is determined as a function of the ascertained current speed of the detected object. Alternatively or additionally, the collision warning is determined as a function of the ascertained height of the detected object. A door opening warning as a collision warning is additionally based on the swivel range of the respective door of the vehicle into the environment. This embodiment generates an effective and reliable collision warning.

Furthermore, it may in particular be provided that the at least three sensed reflection signals for ascertaining the three-dimensional position of a reflection point are used or selected from the six sensed reflection signals based on at least one property of the reflection signals and/or based on a property of the object which causes the reflection or on which the reflection takes place. In this case, the properties of the reflection signals can be compared to one another or to a threshold value; for example, an amplitude height of the reflection signal and/or a number of and/or the height and/or the width of at least one maximum of the reflection signal or of a peak of the reflection signal, which is in particular above an amplitude height, are compared to one another or to the threshold value. Furthermore, the at least three sensed reflection signals for ascertaining the three-dimensional position of a reflection point can be selected based on a property of the object, in particular the type of the object and/or the height of the object. For objects with a height smaller than a threshold value, the three reflection signals that have been transmitted by the transmitted ultrasonic signal with a spatial direction (211, 221) that is lower relative to the ground are in particular used. Alternatively or additionally, for different object types, the three reflection signals of the ultrasonic signal that supply more accurate or stronger reflection signals for the respective object type are used; for example, based on the object type, the reflection signals of the ultrasonic signal with a narrower or wider sonic cone and/or the reflection signals of the ultrasonic signal with a lower or higher ultrasonic frequency are selected or used. The object type can in this case be carried out as a function of the reflection signals and/or in a camera-based manner, in particular via a trained machine detection method, in particular a neural network. For particular or all object types, reflection signals of different ultrasonic signals can be used or selected, for example two reflection signals per ultrasonic signal. The ascertained position of the reflection point is ascertained more reliably and more accurately by this embodiment.

The present invention also relates to a computer program comprising commands which, when the program is executed by a computer, cause the computer to perform the steps of the method according to the present invention.

The present invention furthermore relates to a computing device, in particular a control unit, a decentralized, or zonal, or central computing unit. The computing device comprises at least one signal input for providing an input signal. The input signal represents at least six reflection signals sensed by the ultrasonic sensor, wherein the reflection signals are respectively based on an ultrasonic signal transmitted by the ultrasonic sensor and reflected on an object in the environment. The computing device also comprises a computing unit, in particular a processor, which is configured such that it performs the steps of the method according to the present invention. Furthermore, the computing device optionally has a signal output for generating an output signal, wherein the output signal in particular represents an ascertained three-dimensional position of a reflection point of the object relative to the ultrasonic sensor or to the vehicle and/or a collision warning regarding the detected object.

The present invention furthermore relates to a vehicle comprising at least one computing device according to the present invention.

Further advantages arise from the following description of exemplary embodiments with respect to the figures.

### BRIEF DESCRIPTION OF THE DRAWINGS

FIG. 1A shows an ultrasonic sensor.

FIG. 1B shows an ultrasonic sensor on the vehicle.

FIG. 2 shows vehicle with ultrasonic sensor and generated ultrasonic signal.

FIGS. 3A and 3B show reflection points of an object.

FIG. 4 shows a flow chart of a method according to an example embodiment of the present invention as a block diagram.

### DETAILED DESCRIPTION OF EXAMPLE EMBODIMENTS

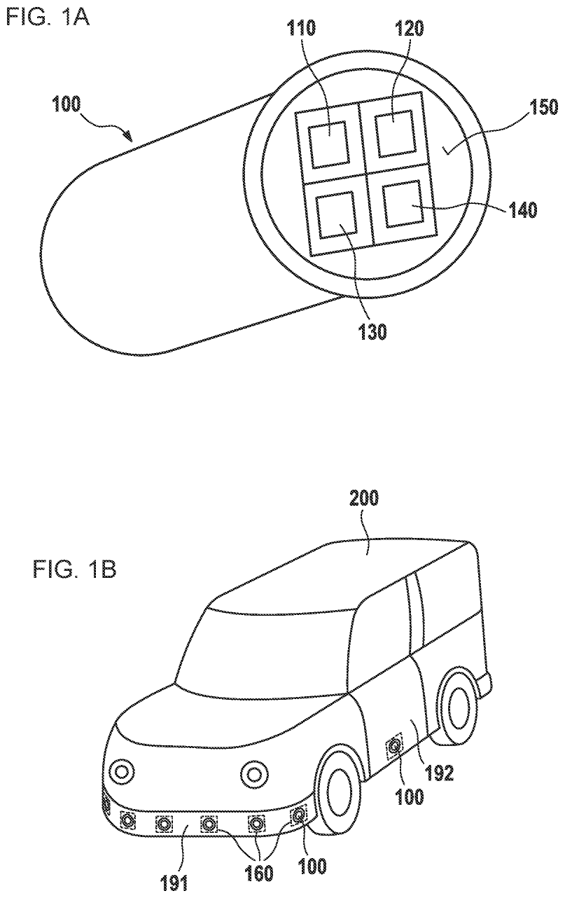

FIG. 1A schematically shows an ultrasonic sensor 100. The ultrasonic sensor comprises at least three sensor elements 110, 120, 130, and 140, wherein at least two sensor elements are arranged at a horizontal offset to one another and at least two sensor elements are arranged at a vertical offset to one another. The sensor elements 110, 120, 130, and 140 are preferably located in a common plane 150. Each of the sensor elements 110 to 140 preferably comprises a sensor membrane and a sensor actuator system configured to deflect, or cause to vibrate, the sensor membrane for the transmission of an ultrasonic signal and to sense received ultrasonic signals as a reflection signal at the sensor membrane. The sensor actuator system can be produced, for example, in MEMS technology.

FIG. 1B shows a vehicle 200 with the ultrasonic sensor 100 shown in FIG. 1A. The ultrasonic sensor 100 is advantageously arranged on a bumper 191 or a side door 192 of a vehicle 200, wherein at least one retaining element 160, shown dashed, is advantageously provided for fixing the ultrasonic sensor 100 to the vehicle 200 and for decoupling mechanical vibrations between the ultrasonic sensor 100 and the vehicle 200. In this case, one or more ultrasonic sensors 100 can be arranged on the bumper 191 and/or the side door 192, in particular, as shown here, six ultrasonic sensors on the bumper 191.

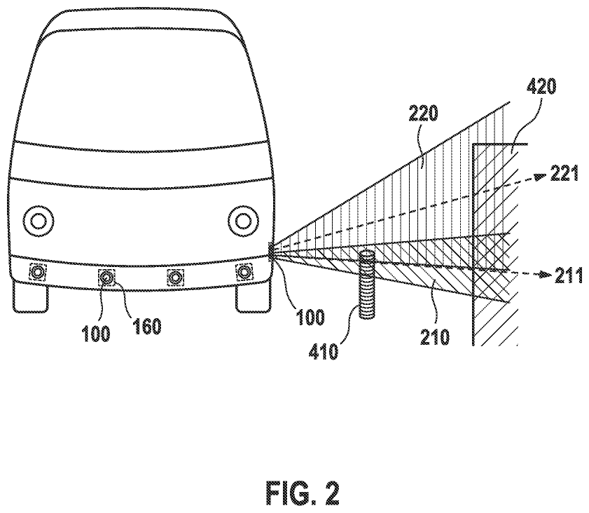

FIG. 2 schematically shows the vehicle 200 of FIG. 1B from the front, wherein the ultrasonic sensor 100 arranged on one side of the vehicle 200 in the bumper 191 transmits a first ultrasonic signal 210 and a second ultrasonic signal 220 in FIG. 2. All ultrasonic sensors 100 can preferably transmit and/or receive ultrasonic signals independently of one another. The first and second ultrasonic signals 210, 220 differ since the two ultrasonic signals are transmitted chronologically one after the other and since the two ultrasonic signals are transmitted in different spatial directions and/or with respectively differently shaped sonic cones and/or with respectively different ultrasonic frequencies. In the exemplary embodiment of FIG. 2, the two ultrasonic signals 210, 220 are transmitted at least in different spatial directions 211, 221, wherein the spatial directions represent central axes of the ultrasonic signals in which the ultrasonic signals propagate.

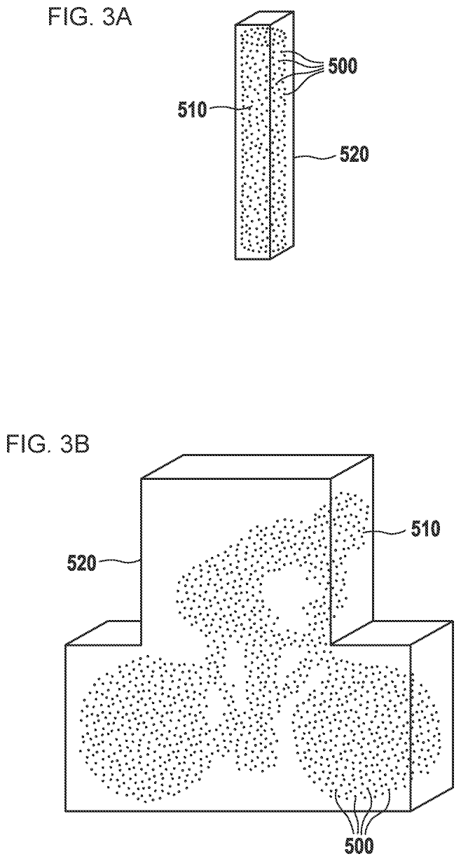

Based on the sensed or measured propagation time T of an ultrasonic signal from the transmission until the sensing at the transmitting ultrasonic sensor, a distance L of a reflection point can be ascertained according to the simple relationship L=½×T×C, wherein the average speed of sound in air is c≈330 m/s. At an ascertained distance of 10 cm or 1 m, the sensed propagation time from the transmission of the ultrasonic signal until the reception or sensing of the reflection signal is thus, for example, approximately 0.6 ms for 10 cm or approximately 6 ms for 1 m. Consequently, in one second, a plurality of ultrasonic signals can be transmitted and associated reflection signals received, and a plurality of positions of reflection points in a defined environment of the vehicle can be ascertained, see also FIGS. 3A and 3B. In principle, distances ascertained in the trilateration are used at unknown angles (in other words distance arcs) in order to determine a point, here the position of a reflection point. Corresponding determination equations of the trilateration can be taken from the literature, wherein three ascertained distances are typically used to determine one position of a reflection point. Here, a trilateration is carried out for each transmitted ultrasonic signal on the basis of the distances, ascertained based on the reflection signals, from this ultrasonic signal, and a position of the associated reflection point is ascertained. Since two different ultrasonic signals are transmitted, the two ascertained positions of the reflection points are combined, e.g., compared to one another or validated and/or averaged. This increases the reliability of the measurement. Furthermore, both distant and nearby objects as well as objects at different heights can be sensed reliably and simultaneously, and different objects located in the same environment direction relative to the vehicle can be differentiated from one another. The ultrasound under consideration here refers to sound at frequencies above the audible frequency range of humans and comprises frequencies from 20 kHz at wavelengths of 1.6 cm to frequencies of approximately 10 GHz at wavelengths of 0.033 μm in air. Air has damping for ultrasound that increases greatly with the frequency.

FIG. 2 schematically shows a first object 410 and a distant, bigger, second object 420 in the environment of the vehicle 200, wherein a plurality of positions of reflection points 500 is advantageously ascertained for the objects 410 and 420.

FIGS. 3A and 3B respectively schematically show a cloud 510 of ascertained reflection points 500. A shape and parameterization of an object box 520 can be determined, for example by means of a neural network, for the cloud 510 shown in FIG. 3A or for the plurality of ascertained positions of reflection points 500. Based on this determined shape and parameterization of the object box 520, a post can be detected as an object according to the positions of the reflection points of FIG. 3A. Another shape and parameterization of another object box 520 can be determined, for example by means of a neural network, for the positions, ascertained in FIG. 3B, of reflection points 500, wherein, based on this object box 520 which represents the positions of the reflection points 500, a bicycle or two-wheeler is detected as a dynamic object. Objects relevant to the distance sensing in vehicles are, for example, a post, a curb or a guardrail as static objects and a third-party vehicle, a pedestrian or a bicycle as dynamic objects.

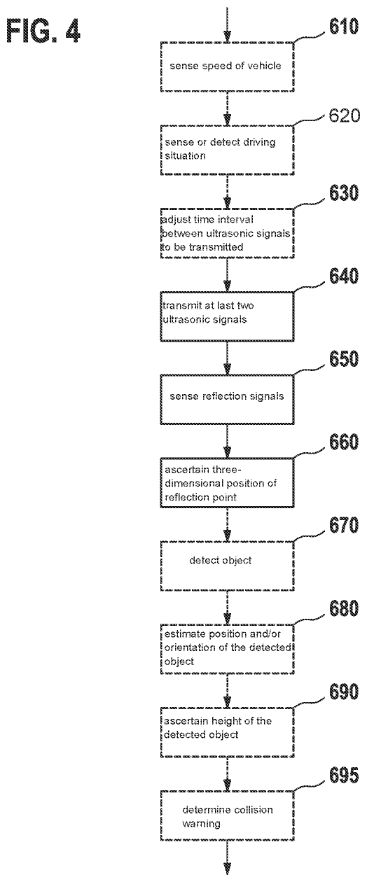

FIG. 4 schematically shows, as a block diagram, a flow chart of the method for ascertaining a three-dimensional position of a reflection point of an object in the environment of a vehicle by means of an ultrasonic sensor. In the optional step 610, it can first be provided that a speed of the vehicle is sensed. In a further optional step 620 of the method, a driving situation of the vehicle can be sensed or detected as a function of a position of the vehicle, as a function of the sensed speed of the vehicle, as a function of an input of the user of the vehicle and/or as a function of a captured camera image of the environment of the vehicle. In another optional step 630, a change in a time interval between ultrasonic signals to be transmitted is adjusted as a function of the sensed speed, wherein the time interval between the transmitted ultrasonic signals is in particular reduced with increasing speed. The method according to the present invention comprises a transmission 640 of at least two ultrasonic signals by means of at least one of the ultrasonic sensor elements of the ultrasonic sensor, wherein the two ultrasonic signals are transmitted chronologically one after the other. The time interval is preferably present between the ultrasonic signals. It can optionally be provided that the transmission 640 of the at least two ultrasonic signals takes place by means of different sensor elements or ultrasonic sensor elements of the ultrasonic sensor.

Furthermore, the transmission 640 of at least one of the ultrasonic signals can optionally take place by means of at least two simultaneously activated different sensor elements of the ultrasonic sensor. In step 640, the two ultrasonic signals are furthermore transmitted in different spatial directions and/or with respectively differently shaped sonic cones and/or with respectively different ultrasonic frequencies. Optionally, the transmission 640 of the at least two ultrasonic signals takes place as a function of the driving situation detected in step 620, in particular if a maneuver situation, a parking process or an unparking process has been detected as the driving situation. It can optionally be provided that, in step 640, at least one of the ultrasonic signals is transmitted as a function of the speed sensed in step 610, wherein the transmitted spatial direction, the shaping of the transmitted sonic cone and/or the transmitted ultrasonic frequency of the ultrasonic signal is changed as a function of the speed. The transmitted ultrasonic signal in particular has a wider sonic cone in the horizontal direction during standstill of the vehicle than during travel of the vehicle. Thereafter, in step 650, the two transmitted ultrasonic signals, each reflected on an object, are respectively sensed or received as reflection signals by means of the at least three sensor elements 110, 120, 130 of the ultrasonic sensor 100. Subsequently, in step 660, the three-dimensional position of a reflection point of the object relative to the ultrasonic sensor 100 or to the vehicle 200 is ascertained based on the at least three sensed reflection signals; the three-dimensional position of the reflection point of the object relative to the ultrasonic sensor 100 or to the vehicle 200 is preferably ascertained based on the at least six sensed reflection signals. It can be provided to select the reflection signals taken into account for ascertaining 660 the three-dimensional position from the six sensed reflection signals, wherein the selection in particular takes place as a function of a property of the reflection signal and/or as a function of a property of the object on which the reflection signals have been reflected. The object can be detected on the basis of the reflection signals and/or in a camera-based manner, in particular via a trained machine detection method, in particular a neural network. In a development of the method, in an optional step 670, an object in the environment of the vehicle is detected via a trained machine detection method, in particular by a neural network, as a function of a plurality of ascertained three-dimensional positions of respectively different reflection points, wherein the detected object is advantageously assigned to the ascertained three-dimensional positions of the respectively different reflection points. It can subsequently be provided that, in an optional step 680, a position and/or an orientation of the detected object in the environment of the vehicle is estimated, in particular in each case relative to the vehicle. This estimation 680 of the position and/or the orientation of the detected object preferably takes place as a function of a main axial direction, wherein the main axial direction is ascertained as a function of the ascertained three-dimensional positions of the reflection points assigned to the object. The main axial direction is in particular ascertained as a function of the smallest mean distance between the reflection points, assigned to the object, and the axis. Alternatively or additionally, the position and/or the orientation of the detected object is estimated in step 680 as a function of a position of a three-dimensional object box around the detected object, wherein the shape of the object box is in particular loaded from a memory based on the detected object and is parameterized as a function of the ascertained three-dimensional positions of the reflection points assigned to the detected object. Alternatively or additionally, the position and/or the orientation of the detected object in step 680 is estimated as a function of the plurality of ascertained three-dimensional positions of reflection points via a trained machine detection method, in particular via a neural network. It can furthermore be provided that, in the optional step 685 not shown, a movement direction and/or a speed of the detected object relative to the vehicle is ascertained based on the positions, estimated over time, of the detected object and/or the orientations, estimated over time, of the detected object and/or the three-dimensional positions, ascertained over time, of reflection points assigned to the object. In addition, in the optional step 690, a height of the detected object relative to the vehicle is ascertained as a function of the estimated position of the detected object and/or of the estimated orientation of the detected object and/or of the plurality of ascertained three-dimensional positions of reflection points. In a further optional step 695, a collision warning between the vehicle and the detected object is determined, wherein the dimensions of the vehicle are in particular taken into account. The determination 695 of the collision warning takes place at least as a function of the estimated current position of the detected object, and/or of the estimated current orientation of the detected object, and/or of the ascertained current movement direction of the detected object, and/or of the ascertained current speed of the detected object, and/or of the ascertained height of the detected object, wherein a door opening warning as a collision warning is additionally based on the swivel range of the respective door of the vehicle into the environment. The collision warning determined in step 695 is preferably indicated to the user of the vehicle in the event of an imminent collision.

What is claimed is:

1. A method for ascertaining a three-dimensional position of a reflection point of an object in an environment of a vehicle using an ultrasonic sensor which has at least three sensor elements, wherein at least two sensor elements are arranged at a horizontal offset to one another, and at least two sensor elements are arranged at a vertical offset to one another, wherein the method comprises the following steps:
transmitting at least two ultrasonic signals using at least one of the sensor elements of the ultrasonic sensor, wherein the at least two ultrasonic signals are transmitted chronologically one after the other, and wherein the at least two ultrasonic signals are transmitted in different spatial directions and/or with respectively differently shaped sonic cones and/or with respectively different ultrasonic frequencies;
sensing each of the at least two transmitted ultrasonic signals reflected on an object as reflection signals using the at least three ultrasonic sensor elements; and
ascertaining the three-dimensional position of a reflection point of the object relative to the ultrasonic sensor or to the vehicle, based on at least three sensed reflection signals, wherein the at least three reflection signals taken into account originate from at least one of the at least two transmitted ultrasonic signals.

2. The method according to claim 1, wherein the transmission of the at least two ultrasonic signals takes place using different sensor elements of the ultrasonic sensor.

3. The method according to claim 1, wherein the transmission of at least one of the ultrasonic signals takes place using at least two simultaneously activated different sensor elements of the ultrasonic sensor.

4. The method according to claim 1, wherein the following step is carried out prior to the transmission of the at least two ultrasonic signals:
detecting a driving situation of the vehicle as a function of a position of the vehicle, and/or as a function of a sensed speed of the vehicle, and/or as a function of an input of a user of the vehicle, and/or as a function of a captured camera image of the environment of the vehicle;
wherein the transmission of the at least two ultrasonic signals takes place as a function of the detected driving situation, including whether a maneuver situation or a parking process or an unparking process has been detected as the driving situation.

5. The method according to claim 1, further comprising:
sensing a speed of the vehicle; and
(i) transmitting at least one ultrasonic signal as a function of the sensed speed, wherein the spatial direction, the shaping of the sonic cone and/or the ultrasonic frequency of the ultrasonic signal is changed as a function of the speed; and/or (ii) changing a time interval between the transmitted ultrasonic signals as a function of the sensed speed, wherein the time interval between the transmitted ultrasonic signals is reduced with increasing speed.

6. The method according to claim 1, further comprising:
detecting an object in the environment of the vehicle as a function of a plurality of ascertained three-dimensional positions of respectively different reflection points via a trained machine detection method including via a neural network, wherein the detected object is assigned to the ascertained three-dimensional positions of the respectively different reflection points.

7. The method according to claim 6, further comprising:
estimating a position and/or an orientation of the detected object in the environment of the vehicle, in particular in each case relative to the vehicle:
i. as a function of a main axial direction, wherein the main axial direction is ascertained as a function of the ascertained three-dimensional positions of the reflection points assigned to the object, wherein the main axial direction is ascertained as a function of a smallest mean distance between the reflection point, assigned to the object, and an axis; and/or
ii. as a function of a position of a three-dimensional object box around the detected object, wherein the shape of the object box is loaded from a memory based on the detected object and is parameterized as a function of the ascertained three-dimensional positions of the reflection points assigned to the detected object; and/or
iii. as a function of the plurality of ascertained three-dimensional positions of reflection points via the trained machine detection method including via a neural network.

8. The method according to claim 7, further comprising:
ascertaining a movement direction and/or a speed of the detected object relative to the vehicle based on the positions, estimated over time, of the detected object and/or the orientations, estimated over time, of the detected object and/or the three-dimensional positions, ascertained over time, of reflection points assigned to the object.

9. The method according to claim 7, further comprising:
ascertaining a height of the detected object relative to the vehicle as a function of the estimated position of the detected object and/or of the estimated orientation of the detected object and/or of the plurality of ascertained three-dimensional positions of reflection points.

10. The method according to claim 9, further comprising:
determining a collision warning between the vehicle and the detected object, wherein dimensions of the vehicle are taken into account, wherein the determination takes place at least as a function of:
i. an estimated current position of the detected object, and/or
ii. an estimated current orientation of the detected object, and/or
iii. an ascertained current movement direction of the detected object, and/or
iv. an ascertained current speed of the detected object, and/or
v. the ascertained height of the detected object;
wherein a door opening warning as a collision warning is based on a swivel range of a respective door of the vehicle into the environment.

11. The method according to claim 1, wherein the at least three sensed reflection signals for ascertaining the three-dimensional position of a reflection point are selected based on at least one property of the reflection signals and/or a property of the object.

12. A non-transitory computer-readable medium on which is stored a computer program including commands for ascertaining a three-dimensional position of a reflection point of an object in an environment of a vehicle using an ultrasonic sensor which has at least three sensor elements, wherein at least two sensor elements are arranged at a horizontal offset to one another, and at least two sensor elements are arranged at a vertical offset to one another, the commands, when executed by a computer, causing the computer to perform the following steps:
transmitting at least two ultrasonic signals using at least one of the sensor elements of the ultrasonic sensor, wherein the at least two ultrasonic signals are transmitted chronologically one after the other, and wherein the at least two ultrasonic signals are transmitted in different spatial directions and/or with respectively differently shaped sonic cones and/or with respectively different ultrasonic frequencies;
sensing each of the at least two transmitted ultrasonic signals reflected on an object as reflection signals using the at least three ultrasonic sensor elements; and
ascertaining the three-dimensional position of a reflection point of the object relative to the ultrasonic sensor or to the vehicle, based on at least three sensed reflection signals, wherein the at least three reflection signals taken into account originate from at least one of the at least two transmitted ultrasonic signals.

13. A computing device including a control unit or a zonal computing unit or a central computing unit, comprising:
a processor configured to ascertain a three-dimensional position of a reflection point of an object in an environment of a vehicle using an ultrasonic sensor which has at least three sensor elements, wherein at least two sensor elements are arranged at a horizontal offset to one another, and at least two sensor elements are arranged at a vertical offset to one another, wherein the processor is configured to:
transmit at least two ultrasonic signals using at least one of the sensor elements of the ultrasonic sensor, wherein the at least two ultrasonic signals are transmitted chronologically one after the other, and wherein the at least two ultrasonic signals are transmitted in different spatial directions and/or with respectively differently shaped sonic cones and/or with respectively different ultrasonic frequencies;
sense each of the at least two transmitted ultrasonic signals reflected on an object as reflection signals using the at least three ultrasonic sensor elements; and
ascertain the three-dimensional position of a reflection point of the object relative to the ultrasonic sensor or to the vehicle, based on at least three sensed reflection signals, wherein the at least three reflection signals taken into account originate from at least one of the at least two transmitted ultrasonic signals; and
a signal input configured to provide to the processor an input signal representing the reflection signals.

14. The computing device according to claim 13, further comprising:
a signal output configured to generate an output signal representing: (i) the ascertained three-dimensional position of the reflection point of the object relative to the ultrasonic sensor or to the vehicle and/or (ii) a collision warning regarding the detected object.

15. A vehicle comprising:
at least one computing device, including:
a processor configured to ascertain a three-dimensional position of a reflection point of an object in an environment of a vehicle using an ultrasonic sensor which has at least three sensor elements, wherein at least two sensor elements are arranged at a horizontal offset to one another, and at least two sensor elements are arranged at a vertical offset to one another, wherein the processor is configured to:
transmit at least two ultrasonic signals using at least one of the sensor elements of the ultrasonic sensor, wherein the at least two ultrasonic signals are transmitted chronologically one after the other, and wherein the at least two ultrasonic signals are transmitted in different spatial directions and/or with respectively differently shaped sonic cones and/or with respectively different ultrasonic frequencies;
sense each of the at least two transmitted ultrasonic signals reflected on an object as reflection signals using the at least three ultrasonic sensor elements; and
ascertain the three-dimensional position of a reflection point of the object relative to the ultrasonic sensor or to the vehicle, based on at least three sensed reflection signals, wherein the at least three reflection signals taken into account originate from at least one of the at least two transmitted ultrasonic signals, and
a signal input configured to provide to the processor an input signal representing the reflection signals.
